(19) United States
(12) Patent Application Publication
(10) Pub. No.: US 2002/0075522 A1
(43) Pub. Date: Jun. 20, 2002

(54) Time administrator and method of adjusting time

(76) Inventor: Takashi Nozu, Tokyo (JP)

Correspondence Address: Michael Best & Friedrich LLC, 401 North Michigan Avenue, Chicago, IL, 60611, US

(21) Appl. No.: 10/023,381

(22) Filed: Dec. 17, 2001

(30) Foreign Application Priority Data
Dec. 19, 2000 (JP) 2000-385478

(51) Int. Cl. H04N 1/00; H04N 1/36

(52) U.S. Cl. 358/413; 358/400; 358/434

(57) ABSTRACT

A time administrator includes (a) a first unit which acts as a clock and transmits a first signal indicative of a standard time, (b) a second unit which makes access to the first unit and receives the first signal, (c) a third unit which judges whether a system for adjusting a current time is adapted and further whether the system is to be applied to the standard time, and (d) a fourth unit which, when the third unit judges that the system is to be applied to the standard time, carries out a specific operation to the standard time, and transmits a second signal indicative of the result of the operation as a current time, and which, when the third unit judges that the system is not to be applied to the standard time, transmits a third signal without carrying out the operation which third signal is indicative of the standard time as a current time.

### BACKGROUND OF THE INVENTION

1. Field of the Invention

The invention relates to a time administrator to be applied to a video tape recorder or a cooking machine for controlling a time, for instance, and more particularly to a time administrator for adjusting a time over a certain period of time in accordance with the daylight saving time system.

2. Description of the Related Art

In countries or regions, a standard time is used as a basis for determining a time at which a working time in a company starts or ends, for instance. However, there is a remarkable difference in a sunrise time among reasons, and hence, if a standard time is kept fixed, there is caused a problem that a daylight time cannot be effectively utilized.

To solve this problem, some countries adapt a system for adjusting a standard time over a limited season. A typical one in such a system is the daylight saving time system in which a few hours are advanced relative to a standard time only in summer.

In a facsimile machine, date and time at which data receives from other facsimile machines and data transmits to other facsimile machines are all stored in a memory equipped therein. For instance, a facsimile machine can be set to make reservation for starting data transmission at a predetermined time in order to have night time discount. Accordingly, in countries or regions adapting a system for adjusting a standard time, such as the daylight saving time system, it would be necessary to adjust a standard time in accordance with the system.

If a facsimile machine includes a calendar for sufficient years and months, the facsimile machine could adjust a standard time only when the system is initially adapted or abandoned. However, a facsimile machine including only a 24-hours clock would have to adjust a standard time at date and time at which the system starts and ends.

In a conventional facsimile machine, an operator has manually adjusted a standard time. For instance, in a time display unit disclosed in Japanese Unexamined Patent Publication No. 2000-275368, a display unit converts displaying a current time not under the daylight saving time system into displaying a current time under the daylight saving time system, or displays a current time, or vice versa, if an operator pushes a certain key such as a clock key.

However, the suggested display unit has a problem that if an operator forgets adjusting a time, a wrong time is displayed or printed, until the operator notices his/her forgetting a time.

In addition, a time usually has to be adjusted at twelve o'clock at midnight. However, an operator often cannot adjust a time at such midnight, resulting in reduction in reliability to a date and time at which data is received or transmitted.

Furthermore, even though an operator adjusted a time at midnight, the operator might wrongly set a period during which a time is kept being adjusted, in which case, a wrong time is displayed until the operator notices the wrong setting.

To avoid those problems, there have been suggested many apparatuses such as facsimile machines which are capable of being adapted to a system for adjusting a time, such as the daylight saving time system.

Before explaining the prior art and the present invention, terms relating to a time, used in the specification, are defined as follows.

The term “a standard time” indicates a time not under a system for adjusting a time, such as the daylight saving time system. The term “standard time data” means data indicative of a standard time.

The term “a current time” indicates a time which is to be displayed presently or which a clock now indicates. If a system for adjusting a time, such as the daylight saving time system, is adapted, the term “a current time” indicates a time under the system, and hence, is different from “a standard time”. If a system for adjusting a time, such as the daylight saving time system, is not adapted, “a current time” is identical with “a standard time”. The term “current time data” means data indicative of a current time.

FIG. 1 is a time administrator suggested in Japanese Unexamined Patent Publication No. 9-230070.

The time administrator 101 is comprised of an internal clock 102, a time controller 103 receiving a signal indicative a current time, from the clock 102, a first display unit 104 receiving the signal from the time controller 103 and displaying a current time, a memory 105 storing date at which the daylight saving time system starts and ends, a switch 106 through which the date is written into the memory 105, and a second display unit 107 indicating whether the switch 106 is on or off.

While the switch 106 is kept off, the time controller 103 causes the first display unit 104 to display a current time indicated by the signal transmitted from the internal clock 102. In other words, while the switch 106 is kept off, a current indicated by the internal clock 102 is displayed in the first display unit 104 regardless of whether it is in the daylight saving time.

When an operator turns the switch 106 on, what is stored in the memory 105 is transmitted to the time controller 103 through the switch 106. The time controller 103 checks a date and time indicated by the internal clock 102, and transmits the time indicated by the internal clock 102, to the first display unit 104, if it is out of the daylight saving time, or adds an extra time to the time indicated by the internal clock 102, and then, transmits the thus adjusted time to the first display unit 104, if it is during the daylight saving time.

Thus, if an operator turns the switch 106 on before the daylight saving time starts, a time under the daylight saving time is displayed in the first display unit 104 concurrently with a start of the daylight saving time, and a current time actually indicated by the internal clock 102 is displayed in the first display unit 104 after the daylight saving time ends.

FIG. 2 is a flow chart of another time administrator which varies a displayed time in dependence on whether it is during the daylight saving time.

The time administrator includes a central processing unit CPU (not illustrated) which carries out a control defined in FIG. 2, by every 100 milliseconds, for instance.

First, it is checked as to what time it is by means of an internal clock, in step S121.

Then, it is judged whether a current time indicated by the internal clock is identical with a first time at which the daylight saving time starts, in step S122.

If they are not identical with each other (NO in step S122), it is judged whether a current time is identical with a second time at which the daylight saving time ends, in step S123.

If a current time is not identical with the second time (NO in step S123), it is judged as to whether a time mode is a daylight saving time mode, in step S124.

If a time mode is a daylight saving time mode (YES in step S124), it is displayed that the time administrator is in the daylight saving time mode, in step S125, and then, a current time is displayed, in step S126.

If a time mode is not a daylight saving time mode (NO in step S124), it is displayed that the time administrator is in a standard time mode, in step S127, and then, a current time is displayed, in step S126.

It is assumed that it is not in the daylight saving time, but daylight saving time starts at a certain date. As a result of repetition of carrying out the control defined in FIG. 2 by means of the central processing unit, it is detected that a current time is identical with a time at which the daylight saving time starts (YES in step S122).

Then, a time difference D between a current time and the daylight saving time is added to the current time C, in step S128.

Then, the central processing unit switches a time mode to a daylight saving time mode, in step S129.

Then, the steps 124, 125, and 126 are repeatedly carried out.

Thereafter, while it is in the daylight saving time, after a current time is inspected in the step S121, a current time under the daylight saving time is displayed in the step S126.

When the daylight saving time ends (YES in step S123), an actual current time X is calculated by subtracting the above-mentioned time difference D from a displayed current time C, in step S130.

Then, the time mode is converted to a standard time mode from the daylight saving time mode, in step S131.

Then, the steps 124, 127 and 126 are repeatedly carried out.

That is, it is displayed that it is now in the standard time mode, in the step S127, and a current time not under the daylight saving time is displayed, in the step S126.

In the conventional time administrator illustrated in FIG. 1, the time controller 103 always checks a time indicated by the internal clock 102 during the daylight saving time, and adjusts a current time by adding a time difference between a current time and the daylight saving time, to a time indicated by the internal clock 102. The thus adjusted time is displayed in the first display unit 104 as a current time.

Thus, the conventional time administrator illustrated in FIG. 1 has an advantage that if an operator once turns the switch 106 on, a time under the daylight saving time is automatically displayed during the daylight saving time. However, the conventional time administrator is accompanied with a problem that the central processing unit has to add the time difference to the daylight saving time, each time a current time is displayed, resulting in an increased load on the central processing unit.

The above-mentioned problem is also caused in the conventional time administrator which operates in accordance with the flow chart illustrated in FIG. 2.

In the time administrator, it is judged whether a current time is a time at which the daylight saving time starts, in step S122, and it is also judged whether a current time is a time at which the daylight saving time ends, in the step S123. Accordingly, the central processing unit has to carry out the steps to be carried out subsequently to the step 121, in a period of time sufficiently short to be able to check a current time, resulting in an increased load on the central processing unit.

If a period of time for repeating the steps illustrated in FIG. 2 is lengthened in order to reduce a load exerted on the central processing unit, the central processing unit might fail checking whether a current time is a time at which the daylight saving time starts or ends. If the central processing unit fails checking whether a current time is a time at which the daylight saving time starts, a standard time not under the daylight saving time is displayed as a current time even while the daylight saving time.

Then, if the central processing unit detects that a current time is a time at which the daylight saving time ends, in step S123, a time difference between a current time and the daylight saving time is subtracted from the current time, in step S130. As a result, even if the daylight saving time ends, a standard time is not displayed as a current time. That is, a wrong time is displayed as a current time forever.

On the other hand, even if a time under the daylight saving time is correctly displayed as a current time, if the central processing unit fails checking whether a current time is a time at which the daylight saving time ends, a wrong time is kept displayed after the daylight saving time has ended.

The conventional time administrator operating in accordance with the flow chart illustrated in FIG. 2 is accompanied with another problem.

For instance, it is assumed that 2:00 a.m. on the first Sunday in April is advanced by an hour to 3:00 a.m., and 2:00 a.m. on the last Sunday in October is put back to 1:00 a.m. both in accordance with the daylight saving time system.

It is also assumed that there is made reservation in a facsimile machine such that data is transmitted through the facsimile machine at 2:10 a.m. on the first Sunday in April. However, under the first mentioned assumption, one minute later from 1:59 a.m. on the last Sunday in October is just 3:00 a.m., resulting in that data which was reserved to transmit at 2:10 a.m. on the last Sunday in October is never transmitted.

Similarly, it is assumed that there is made reservation in a facsimile machine such that data is transmitted through the facsimile machine at 1:10 a.m. on the last Sunday in October. Under the first mentioned assumption, one minute later from 1:59 a.m. on the last Sunday in October is 1:00 a.m. again. Hence, data which was reserved to transmit at 1:10 a.m. on the last Sunday in October might be transmitted twice.

Japanese Unexamined Utility Model Publication No. 1-126761 has suggested a facsimile machine including a memory storing a time lag between the facsimile machine and receivers, and a timer indicating a current time. When a telephone number is input into the facsimile machine, the facsimile machine calculates a time in a receiver, based on the current time and the time lag between the facsimile machine and the receiver, adds the time in the receiver to image data, and then, transmits the data to the receiver.

Japanese Unexamined Patent Publication No. 3-165657 has suggested a facsimile machine which stores a first time at which the facsimile machine receives a call, identifies a region where a receiver is, based on subscriber data, calculates a time lag in accordance with a time administration table, and adds the time lag to both the first time and a second time at which the facsimile machine transmits data. The daylight saving time and a time difference between the daylight saving time and a standard time are both stored in the time administration table. The facsimile machine further includes means for judging whether it is in the daylight saving time in a target region, and calculates a time lag, based on the above-mentioned time difference, if it is in the daylight saving time.

Japanese Unexamined Patent Publication No. 6-284236 has suggested a facsimile machine including a clock, and a switch which switches the clock between a standard time mode and a daylight saving time mode.

Japanese Unexamined Patent Publication No. 6-326794 has suggested a facsimile machine including a switch for selecting a standard time or a daylight saving time, a display unit which displays a time in accordance with the standard time or the daylight saving time, a printer unit which prints the time in accordance with the standard time or the daylight saving time, onto a file, and outputs the file, and an adder which adds an identifier to the file for letting a user know that the daylight saving time is selected.

Japanese Unexamined Patent Publication No. 8-172501 has suggested a facsimile machine including a clock transmitting a signal indicative of a current time, a display unit which displays the current time indicated by the signal transmitted from the clock, a first unit which judges whether it is in a particular period in which a current time is advanced or put back by a predetermined hour relative to a standard time, and a second unit which calculates a date and time under the particular period. When the first unit judges that it is now in the particular period, based on the signal transmitted from the clock, the second unit calculates a date and time under the particular period, based on the signal, and the display unit displays the date and time under the particular period together with an identifier by which a viewer can realize that the displayed date and time is one under the particular period.

Japanese Unexamined Patent Publication No. 11-308753 has suggested a measurement apparatus including a clock for protecting, controlling and measuring an electric power system, a first unit which receives a signal transmitted from the clock, and judges whether it is now in the daylight saving time, based on the received signal, and a second unit which modifies a time indicated by the clock into a time under the daylight saving time, if the first unit judges that it is now in the daylight saving time.

However, the above-mentioned problem remains unsolved even in those Publications.

### SUMMARY OF THE INVENTION

In view of the above-mentioned problems in the conventional time administrators, it is an object of the present invention to provide a time administrator and a method of adjusting a time both of which are capable of adjusting a time in accordance with a system for adjusting a time, such as the daylight saving time system, without exerting extra load on a processing unit.

In one aspect of the present invention, there is provided a time administrator including (a) a first unit which acts as a clock and transmits a first signal indicative of a standard time, (b) a second unit which makes access to the first unit and receives the first signal, (c) a third unit which judges whether a system for adjusting a current time is adapted and further whether the system is to be applied to the standard time, and (d) a fourth unit which, when the third unit judges that the system is to be applied to the standard time, carries out a specific operation to the standard time, and transmits a second signal indicative of the result of the operation as a current time, and which, when the third unit judges that the system is not to be applied to the standard time, transmits a third signal without carrying out the operation which third signal is indicative of the standard time as a current time.

In the above-mentioned time administrator, the first unit may be designed to measure a time independently of a system for adjusting a time over a predetermined period of time, such as the daylight saving time, to thereby indicate a standard time. The second unit may be designed to make access to the first unit only when it is necessary for the second unit to know a current time not for the purpose of always displaying a current time.

In the above-mentioned time administrator, the second unit may be designed to make access to the first unit only when it is necessary to know a current time not for the purpose of always displaying a current time. Hence, it would be possible to reduce a load to be exerted on a processing unit. In addition, if it is not necessary to adapt a current time to a system for adjusting a time, it would be possible to further reduce a load to be exerted on a processing unit, because any calculation is not necessary to be carried out to a current time.

For instance, the system for adjusting a current time is a daylight saving time.

There is further provided a time administrator including (a) a first unit which acts as a clock and transmits a first signal indicative of a standard time, (b) a second unit which makes access to the first unit and receives the first signal, (c) a third unit which judges whether a system for adjusting a current time is adapted and further whether the system is to be applied to the standard time, (d) a fourth unit which, when the third unit judges that the system is to be applied to the standard time, carries out a specific operation to the standard time, and transmits a second signal indicative of the result of the operation as a current time, and which, when the third unit judges that the system is not to be applied to the standard time, transmits a third signal without carrying out the operation which third signal is indicative of the standard time as a current time, and (e) a fifth unit which visually displays the current time indicated by the third signal.

In the above-mentioned time administrator, the first unit may be designed to measure a time independently of a system for adjusting a time over a predetermined period of time, such as the daylight saving time, to thereby indicate a standard time. The second unit may be designed to make access to the first unit only when it is necessary for the second unit to know a current time not for the purpose of always displaying a current time.

In the above-mentioned time administrator, the second unit may be designed to make access to the first unit only when it is necessary to know a current time not for the purpose of always displaying a current time. Hence, it would be possible to reduce a load to be exerted on a processing unit. In addition, if it is not necessary to adapt a current time to a system for adjusting a time, it would be possible to further reduce a load to be exerted on a processing unit, because any calculation is not necessary to be carried out to a current time.

The second unit makes access to the first unit when communication results are stored in a memory in a facsimile machine.

There is still further provided a time administrator including (a) a first unit which acts as a clock and transmits a first signal indicative of a standard time, (b) a second unit which makes access to the first unit and receives the first signal, (c) a third unit which judges whether a system for adjusting a current time is adapted and further whether the system is to be applied to the standard time, and (d) a fourth unit which, when the third unit judges that the system is to be applied to the standard time, carries out a specific operation to the standard time, and transmits a second signal indicative of the result of the operation as a current time, which, when the third unit judges that the system is not to be applied to the standard time, transmits a third signal without carrying out the operation which third signal is indicative of the standard time as a current time, which compares the current time to a specific time at which a specific action has to start, and which starts the specific action, if the current time is identical with the specific time.

In the above-mentioned time administrator, the first unit may be designed to measure a time independently of a system for adjusting a time over a predetermined period of time, such as the daylight saving time, to thereby indicate a standard time. The second unit may be designed to make access to the first unit only when it is necessary for the second unit to know a current time not for the purpose of always displaying a current time. For instance, the second unit makes access to the first unit when reservation for transmitting data through a facsimile machine is made.

In the above-mentioned time administrator, the second unit may be designed to make access to the first unit only when it is necessary to know a current time not for the purpose of always displaying a current time. Hence, it would be possible to reduce a load to be exerted on a processing unit. In addition, if it is not necessary to adapt a current time to a system for adjusting a time, it would be possible to further reduce a load to be exerted on a processing unit, because any calculation is not necessary to be carried out to a current time.

In another aspect of the present invention, there is provided a method of adjusting a time, including the steps of (a) judging whether a system for adjusting a current time is adapted and further whether the system is to be applied to a standard time, and (b) carrying out a specific operation to the standard time, when the system is judged to be applied to the standard time, or transmitting a signal without carrying out the operation which signal is indicative of the standard time as a current time, when the system is judged not to be applied to the standard time.

The method may further include the step of visually displaying the current time indicated by the signal.

The method may further include the steps of (c) comparing the current time to a specific time at which a specific action has to start, and (d) starting the specific action, if the current time is identical with the specific time.

In still another aspect of the present invention, there is provided a facsimile machine including (a) a clock which transmits a first signal indicative of a standard time, (b) a time controller which makes access to the clock and receives the first signal, (c) a judging unit which judges whether a system for adjusting a current time is adapted and further whether the system is to be applied to the standard time, (d) a facsimile controller which, when the judging unit judges that the system is to be applied to the standard time, carries out a specific operation to the standard time, and transmits a second signal indicative of the result of the operation as a current time, and which, when the judging unit judges that the system is not to be applied to the standard time, transmits a third signal without carrying out the operation which third signal is indicative of the standard time as a current time, (e) a protocol controller connected to a communication line and controlling communication in the facsimile machine, (f) a printer controller which controls an operation of a printer, and (g) a scanner which reads data.

The facsimile machine may further include a display unit which visually displays the current time indicated by the third signal.

The facsimile machine may further include a memory, and the time controller makes access to the first unit when communication results are stored in the memory.

The facsimile controller may be designed to compare the current time to a specific time at which a specific action has to start, and start the specific action, if the current time is identical with the specific time.

The time controller may be designed to make access to the clock when reservation for transmitting data through the facsimile machine is made.

The advantages obtained by the aforementioned present invention will be described hereinbelow.

In the above-mentioned time administrator, the first unit may be designed to measure a time independently of a system for adjusting a time over a predetermined period of time, such as the daylight saving time, to thereby indicate a standard time. The second unit may be designed to make access to the first unit only when it is necessary for the second unit to know a current time not for the purpose of always displaying a current time. Hence, since it is no longer necessary to display a current time with judging whether the above-mentioned system is adapted to a current time or not, it would be possible to not only reduce a load to be exerted on a processing unit, but also avoid wrong operation in an apparatus including the above-mentioned time administrator, caused by wrongly judging a current time, because it is no longer necessary to make frequent access to the first unit.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of the first conventional time administrator.

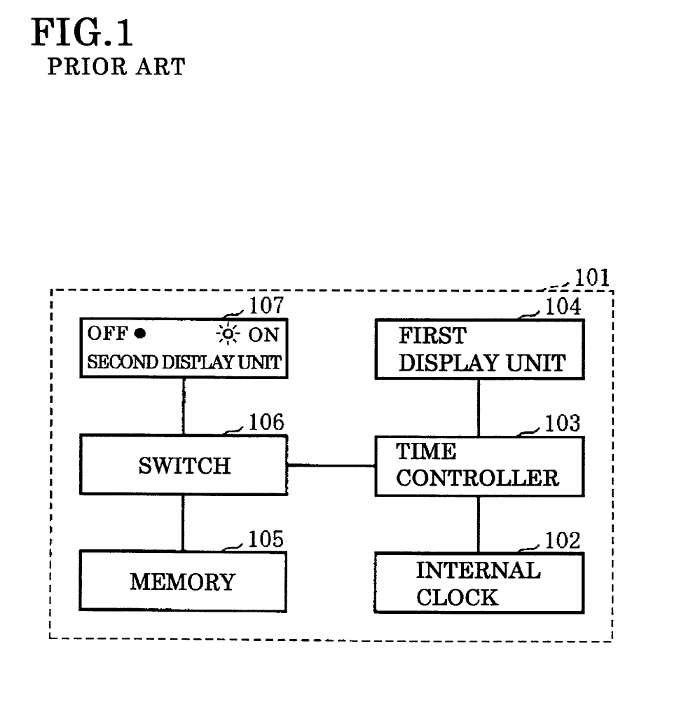

FIG. 2 is a flow chart of the steps to be carried out by the second conventional time administrator.

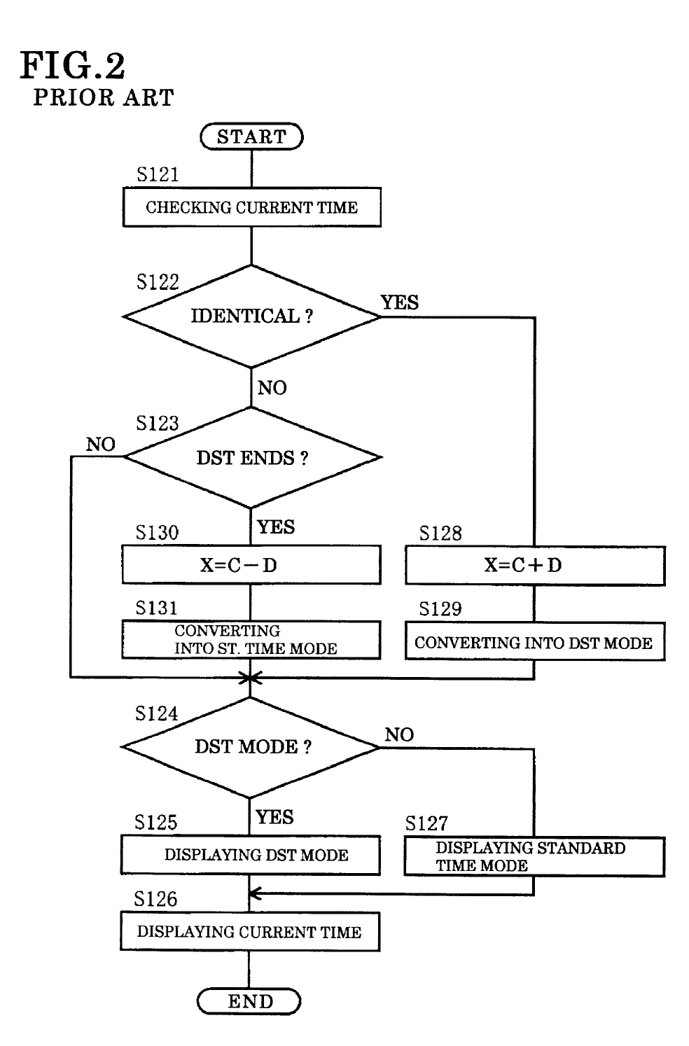

FIG. 3 is a block diagram of a facsimile machine to which the time administrator in accordance with the present invention is applied.

FIG. 4 is a flow chart to be carried out by the facsimile machine illustrated in FIG. 3.

FIG. 5 is a flow chart of the step S235 illustrated in FIG. 4.

FIG. 6 is a flow chart of the step S252 illustrated in FIG. 4.

FIG. 7 is a flow chart to be carried out by the time controller illustrated in FIG. 3.

FIG. 8 is a flow chart to be carried out by the DST detector illustrated in FIG. 3.

FIG. 9 is a flow chart of the step S236 illustrated in FIG. 4.

FIG. 10 is a flow chart to be carried out when the facsimile machine transmits data.

FIG. 11 is a block diagram of another facsimile machine to which the time administrator in accordance with the present invention is applied.

FIG. 12 is a flow chart to be carried out by the facsimile machine illustrated in FIG. 11.

FIG. 13 is a flow chart of the step S423 illustrated in FIG. 12.

### DESCRIPTION OF THE PREFERRED EMBODIMENTS

Preferred embodiments in accordance with the present invention will be explained hereinbelow with reference to drawings.

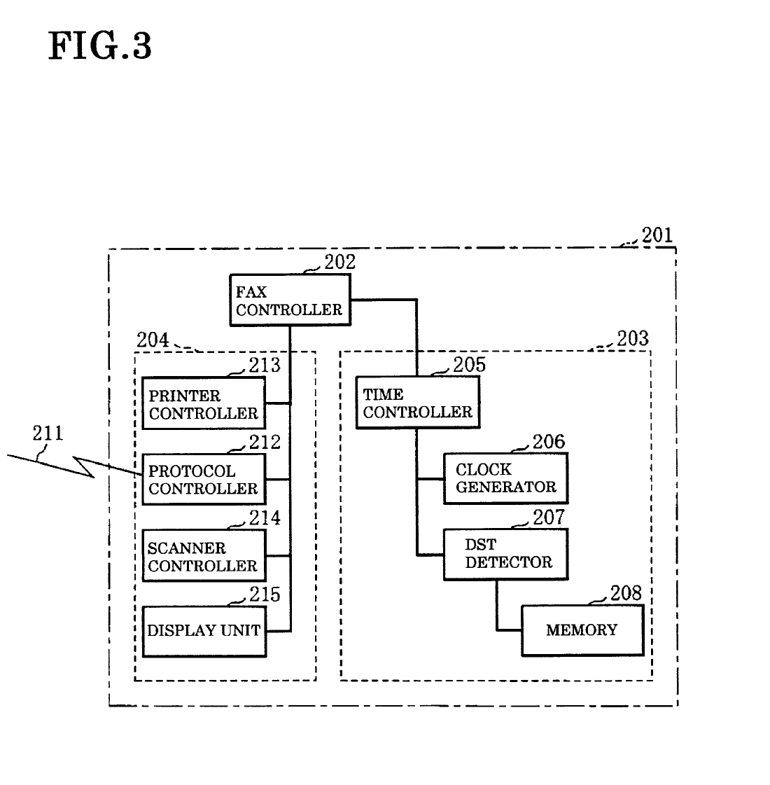

FIG. 3 is a block diagram of a facsimile machine to which the time administrator in accordance with the first embodiment is applied.

The illustrated facsimile machine 201 is comprised of a facsimile controller 202, a time administrator 203 electrically connected to and controlled by the facsimile controller 202, and an input/output (I/O) section 204 electrically connected to and controlled by the facsimile controller 202.

Though not illustrated, the facsimile controller 202 includes a central processing unit (CPU), a read only memory (ROM) storing a control program, and a random access memory (RAM).

The time administrator 203 is comprised of a time controller 205 electrically connected to the facsimile controller 202, a clock generator 206 transmitting a clock signal based on which a time is measured, a daylight saving time detector 207 which judges whether it is in the daylight saving time or not, and a memory 208 storing data about dates at which the daylight saving time starts and ends. The clock generator 206 and the daylight saving time detector 207 are both electrically connected to the time controller 205. The memory 208 is electrically connected to the daylight saving time detector 207.

The input/output section 204 is comprised of a protocol controller 212 connected to a communication line 211, a printer controller 213 controlling a printer (not illustrated) which prints data having been received, onto a sheet, a scanner controller 214 controlling a scanner (not illustrated) which reads out image data of a manuscript, and a display unit 215 displaying data to be transmitted.

The facsimile machine 201 is designed not to display a current time in the display unit 215 in a stand-by mode. This is because it is not necessary to display a current time in a stand-by mode, since a lot of clocks are already equipped in an office. Hence, the facsimile machine 201 is designed not to display a current time in the display unit 215, but print a current time onto a sheet when the printer controller 213 causes the printer to print transmitted or received data onto the sheet.

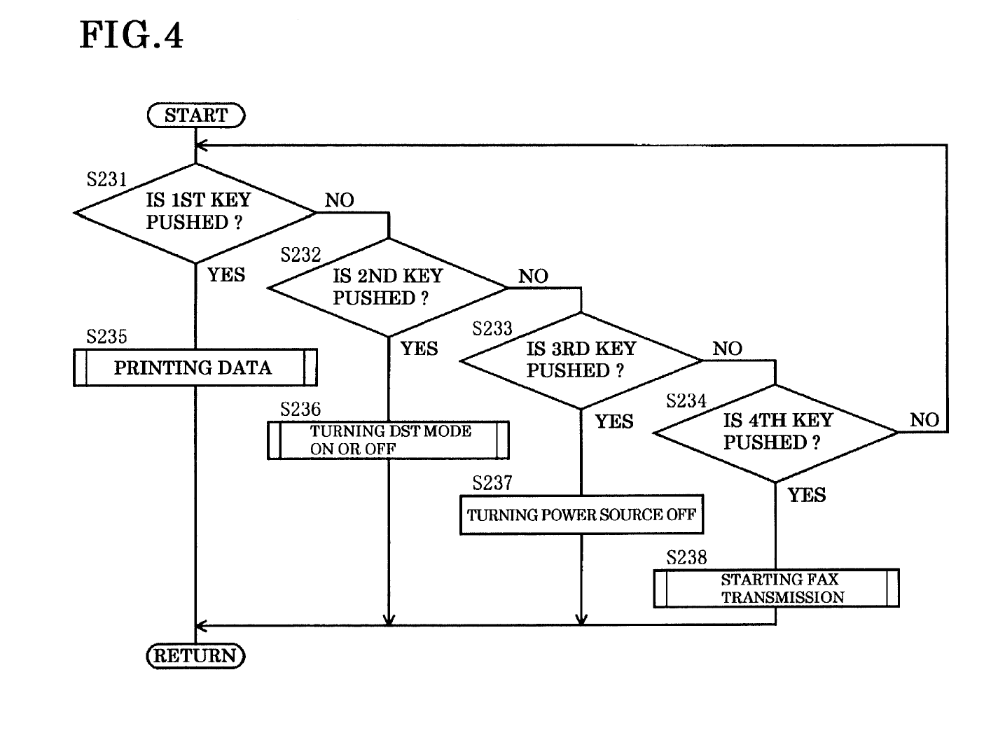

FIG. 4 is a flow chart of steps to be carried out by the facsimile machine 201.

The facsimile controller 202 repeatedly monitors whether a first key (not illustrated) for printing transmitted data onto a sheet is pushed or not, in step S231, whether a second key (not illustrated) for turning a daylight saving time mode on or off is pushed, in step S232, whether a third key (not illustrated) for turning power source off is pushed, in step S233, and whether a fourth key (not illustrated) for starting data transmission is pushed, in step S234. That is, the facsimile controller 202 carried out the above-mentioned monitoring not only for the purpose of checking whether it is now in the daylight saving time. When the first to fourth keys are not pushed (NO in step S234), the facsimile machine 201 is in a stand-by mode.

If an operator pushes the first key while the facsimile machine 201 is in the stand-by mode (YES in step S231), the facsimile controller 202 detects that the first key is pushed, and causes the printer to print data having been transmitted or received, in step S235.

If an operator pushes the second key while the facsimile machine 201 is in the stand-by mode (YES in step S232), the facsimile controller 202 detects that the second key is pushed, and causes the daylight saving time detector 207 to turn the daylight saving time mode on or off, in step S236.

If an operator pushes the third key while the facsimile machine 201 is in the stand-by mode (YES in step S233), the facsimile controller 202 detects that the third key is pushed, and turns a power source off, in step S237.

If an operator pushes the fourth key while the facsimile machine 201 is in the stand-by mode (YES in step S234), the facsimile controller 202 detects that the fourth key is pushed, and causes the protocol controller 212 to start facsimile transmission, in step S238.

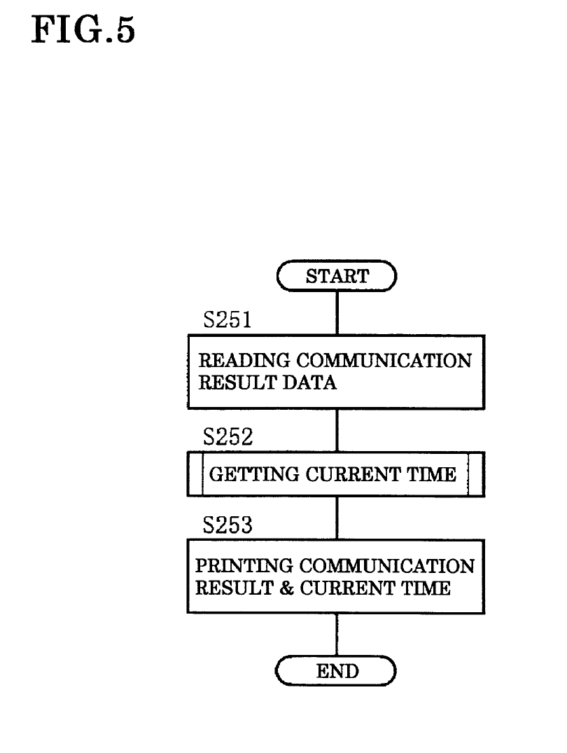

FIG. 5 is a flow chart of steps to be carried out in step S235.

When an operator pushes the first key (YES in step S231), the facsimile controller 202 reads communication result data out of a memory (not illustrated), in step S251. Herein, the communication result data means data including facsimile receivers, a date and time at which facsimile transmission was carried out, and other information relating to facsimile transmission.

Then, the facsimile controller 202 receives a signal indicative of a current time, from the time controller 205, in step S252, and causes the printer to print the communication result and the current time together onto a sheet, in step S253. If a country or a region where the facsimile machine 201 is adapts the daylight saving time, and further if it is now in the daylight saving time, a time adjusted in accordance with the daylight saving time is printed onto a sheet. If the country or the region does not adapt the daylight saving time, or if it is not in the daylight saving time, a standard time is printed onto a sheet.

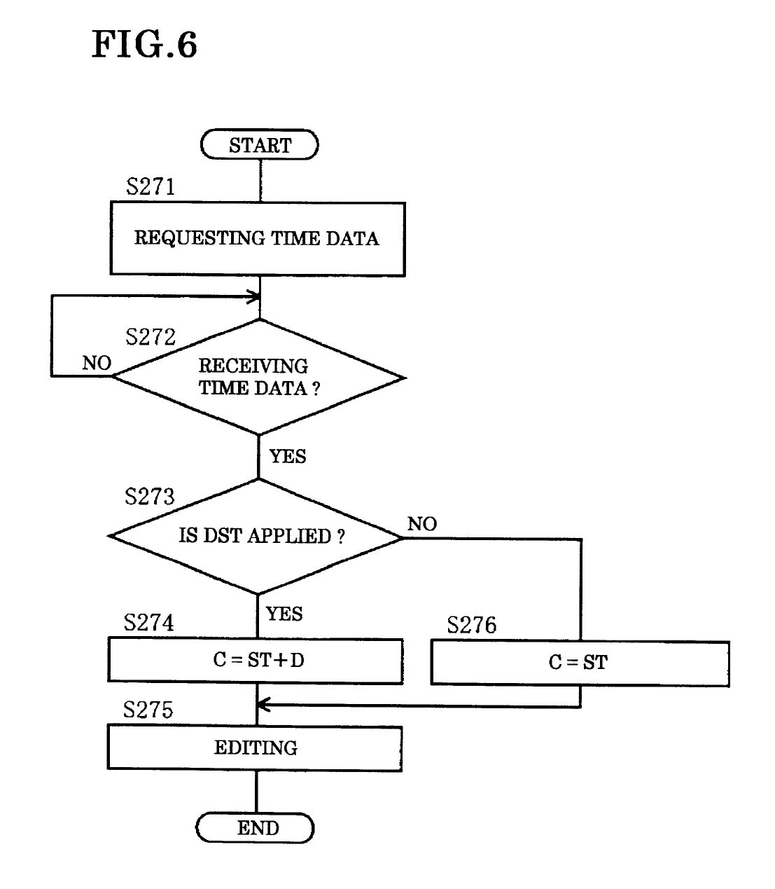

FIG. 6 is a flow chart showing steps to be carried out by the facsimile controller 202 in step S252.

First, the facsimile controller 202 requests the time controller 205 to transmit time data for calculating a current time, to the time controller 205, in step S271. Herein, time data indicates data based on which a current time can be calculated. Specifically, if the daylight saving time is to be applied to the facsimile machine 201, the time data indicates data to calculate a current time under the daylight saving time, whereas if the daylight saving time is not applied to the facsimile machine 201, the time data merely indicates a standard time.

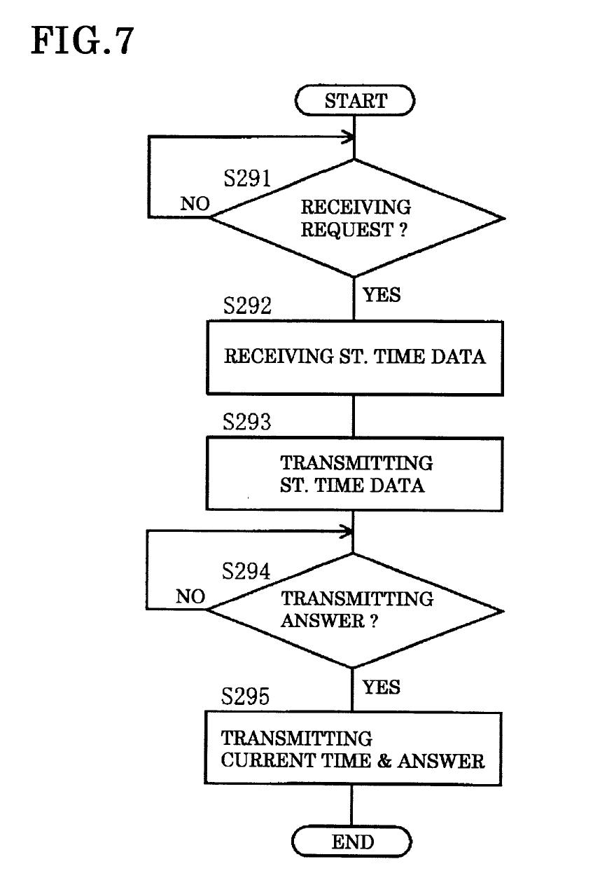

FIG. 7 is a flow chart showing steps to be carried out by the time controller 205 when the facsimile controller 202 makes a request to the time controller 205 to transmit the time data to the facsimile controller 202.

On receipt of the request from the facsimile controller 202 (YES in step S291), the time controller 205 receives a signal indicative of a standard time, from the clock generator 206, in step S292.

The time controller 205 informs the daylight saving time detector 207 of the standard time indicated by the signal received from the clock generator 206, in step S293. This is because the time controller 205 has to know whether the daylight saving time is to be applied to the facsimile machine 201 or not, namely whether the above-mentioned second key is pushed or not.

If the daylight saving time detector 207 transmits an answer back to the time controller 205 (YES in step S294), the time controller 205 transmits both a current time and the answer transmitted from the daylight saving time detector 207, to the facsimile controller 202 as time data, in step S295.

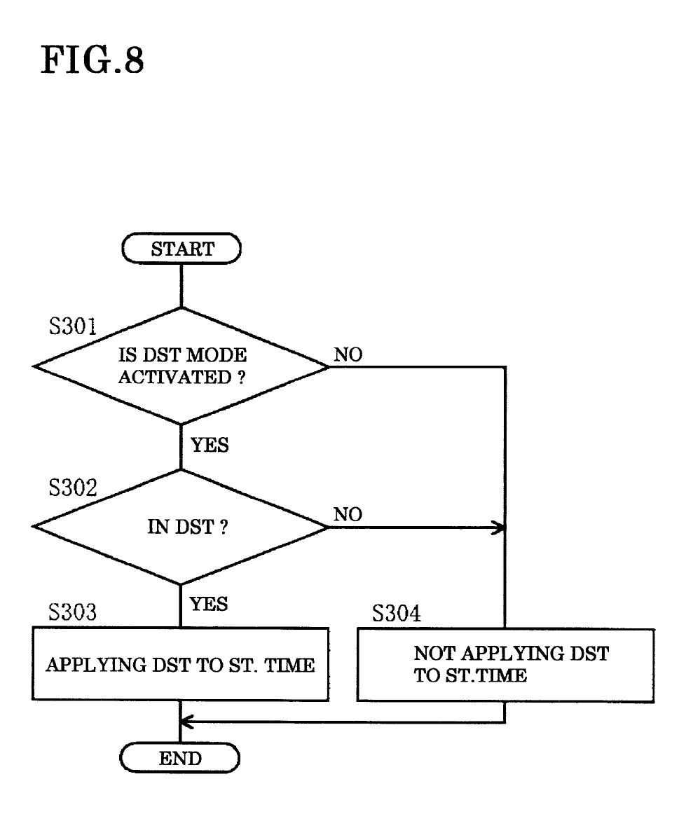

FIG. 8 is a flow chart of steps to be carried out by the daylight saving time detector 207 when the daylight saving time detector 207 receives the standard time data from the time controller 205.

On receipt of the standard time data from the time controller 205, the daylight saving time detector 207 checks whether the daylight saving time mode is activated or not, in step S301.

If the daylight saving time mode is activated (YES in step S301), the daylight saving time detector 207 further checks whether it is now in the daylight saving time or not, in step S302, based on data stored in the memory 208 and the standard time data.

If the daylight saving time detector 207 judges that it is in the daylight saving time (YES in step S302), the daylight saving time detector 207 transmits the judgment result to the time controller 205, in step S303, in which case, the time controller 205 adjusts a standard time in accordance with the daylight saving time, as mentioned later.

If the daylight saving time mode is not activated (NO in step S301), or if it is not in the daylight saving time (NO in step S302), the daylight saving time detector 207 transmits the judgment result to the time controller 205, in step S304, in which case, the time controller 205 does not adjust a standard time in accordance with the daylight saving time.

The time controller 205 transmits the judgment result of the daylight saving time detector 207 to the facsimile controller 202.

Referring back to FIG. 6, on receipt of the time data from the time controller 205 (YES in step S272), the facsimile controller 202 judges whether the daylight saving time is to be applied to the facsimile machine 201, based on the judgment result of the daylight saving time detector 207, in step S273.

If the daylight saving time is to be applied to the facsimile machine 201 (YES in step S273), the facsimile controller 202 adds a time difference D to the standard time ST transmitted from the time controller 205 as the time data, to thereby calculate a current time C, in step S274.

Then, the facsimile controller 202 edits the thus calculated current time for printing, in step S275. Thereafter, the current time is printed onto a sheet together with the communication data, in step S253 illustrated in FIG. 5.

If the daylight saving time is not to be applied to the facsimile machine 201 (NO in step S273), which means that the daylight saving time is not adapted in the country or region, or that it is not in the daylight saving time, the facsimile controller 202 selects a standard time obtained as the time data, as a current time to be printed, in step S276.

Then, the facsimile controller 202 edits the thus obtained current time for printing, in step S275. Thereafter, the current time is printed onto a sheet together with the communication data, in step S253 illustrated in FIG. 5.

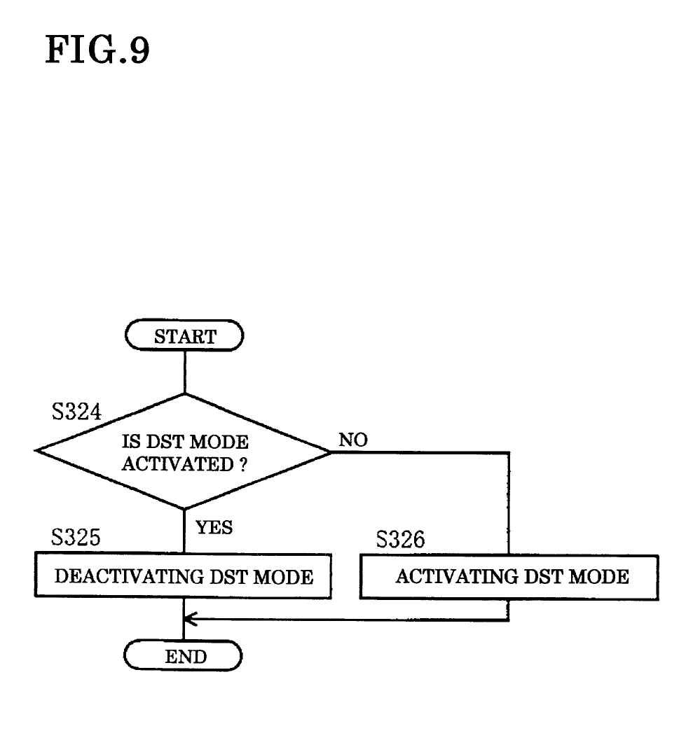

FIG. 9 is a flow chart of steps to be carried out in step S236 illustrated in FIG. 4.

When the second key is pushed (YES in step S232), the facsimile controller 202, if the daylight saving time mode is activated (YES in step S324), deactivates the daylight saving time mode, in step S325.

When the second key is pushed (YES in step S232), the facsimile controller 202, if the daylight saving time mode is not activated (NO in step S324), activates the daylight saving time mode, in step S326.

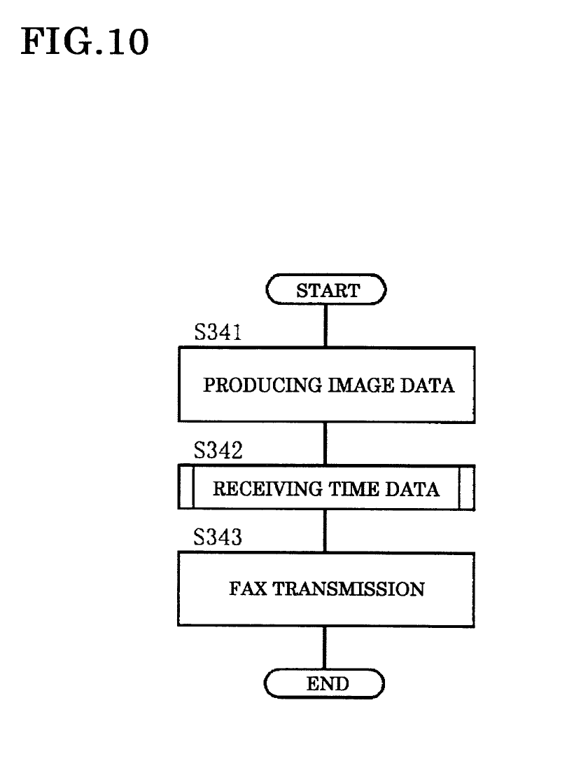

FIG. 10 is a flow chart of steps for carrying out facsimile transmission.

When the fourth key is pushed in step S234 illustrated in FIG. 4, the scanner controller 214 operates the scanner (not illustrated) to read a manuscript for producing image data to be transmitted, in step S341.

At the same time, the facsimile controller 202 receives a facsimile number of a receiver and other various parameters. Herein, the parameters include data necessary for producing and transmitting image data through the facsimile machine 201. For instance, the parameters include a resolution and data indicative of whether image data is comprised only of letters, pictures or combination thereof.

The facsimile controller 202 has to know a current time in order to print the current time to the image data to be transmitted. Hence, the facsimile controller 202 carries out step S342 just before facsimile transmission for knowing a current time. The facsimile controller 202 carries out step S342 for knowing a current time in the same way as the above-mentioned step S252 illustrated in FIG. 5. Specifically, the steps illustrated in FIG. 6 are carried out.

After knowing the current time, the facsimile controller 202 carries out facsimile transmission through the use of image data having been produced in step S341 and the current time obtained in step S342, in step S343.

As having been explained so far, the facsimile machine 201 in the above-mentioned embodiment adjusts a standard time in accordance with the daylight saving time system only when a current time is to be printed onto a printing sheet, or when image data is transmitted to a receiver. That is, it is not necessary to adjust a time in accordance with the daylight saving time system in a short interval such as one second. Accordingly, it is now possible to significantly reduce a load exerted on the facsimile controller 202 when it adjusts a standard time in accordance with the daylight saving time system.

In the above-mentioned embodiment, the facsimile machine 201 is designed to be able to not only print and receive data, but also transmit image data. However, some facsimile machines may have only printing function, data-receiving function, or data-transmitting function. In such facsimile machines, it would be possible to reduce a load to be exerted on a facsimile machine, since a current time is adjusted only when data is received or transmitted.

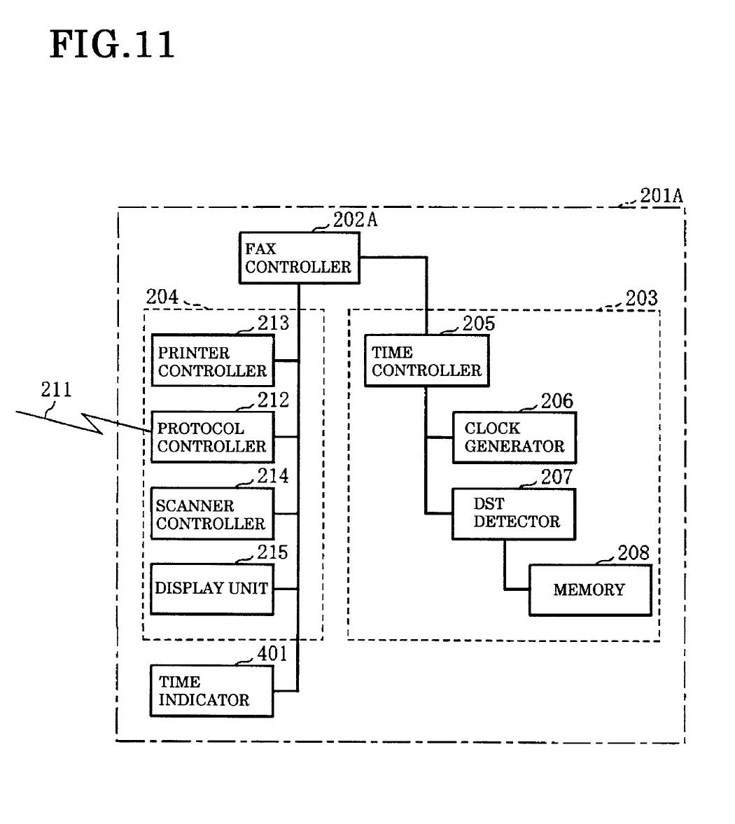

FIG. 11 is a block diagram of a facsimile machine 201A to which the time administrator in accordance with the second embodiment is applied.

Parts or elements in the facsimile machine 201A that correspond to those of the facsimile machine illustrated in FIG. 3 have been provided with the same reference numerals.

The facsimile machine 201A is designed to additionally include a time indicator 401 in comparison with the facsimile machine 201. The time indicator 401 stores a time at which a user wants to transmit data through the facsimile machine 201A, and transmits an instruction to the facsimile controller 202 at the time to start facsimile transmission.

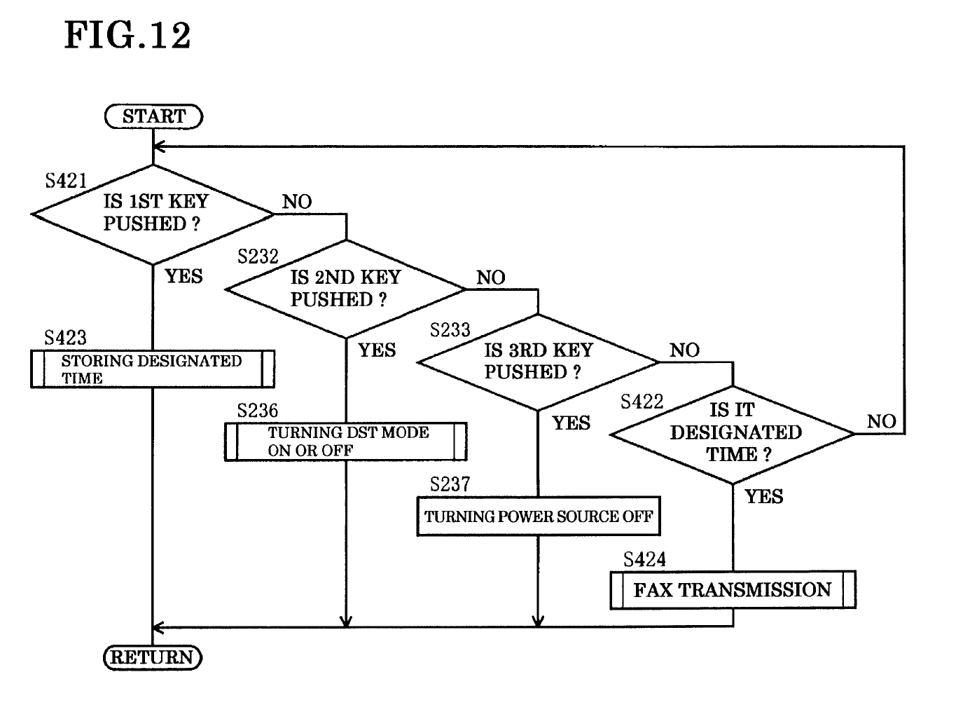

FIG. 12 is a flow chart of steps to be carried out by the facsimile machine 201A. In FIG. 12 steps to be carried out by the facsimile machine 201A and corresponding to those of the facsimile machine illustrated in FIG. 3 have been provided with the same reference numerals.

The facsimile controller 202A in the facsimile machine 201A repeatedly monitors whether a first key (not illustrated) for designating a time at which data is to be transmitted is pushed or not, in step S421, whether a second key (not illustrated) for turning a daylight saving time mode on or off is pushed, in step S232, whether a third key (not illustrated) for turning power source off is pushed, in step S233, and whether it is the designated time or not, in step S422. That is, the facsimile controller 202A carried out the above-mentioned monitoring not only for the purpose of checking whether it is now in the daylight saving time. When the first to third keys are not pushed and further when it is not the designated time (NO in step S422), the facsimile machine 201A is in a stand-by mode.

If an operator pushes the first key while the facsimile machine 201A is in the stand-by mode (YES in step S421), the facsimile controller 202A detects that the first key is pushed, and stores a time designated by the operator, into the time indicator 401, in step S423.

If an operator pushes the second key while the facsimile machine 201A is in the stand-by mode (YES in step S232), the facsimile controller 202A detects that the second key is pushed, and causes the daylight saving time detector 207 to turn the daylight saving time mode on or off, in step S236.

If an operator pushes the third key while the facsimile machine 201A is in the stand-by mode (YES in step S233), the facsimile controller 202A detects that the third key is pushed, and turns a power source off, in step S237.

If the time designated by the operator has come while the facsimile machine 201A is in the stand-by mode (YES in step S422), steps for transmitting data at the designated time start, in step S424.

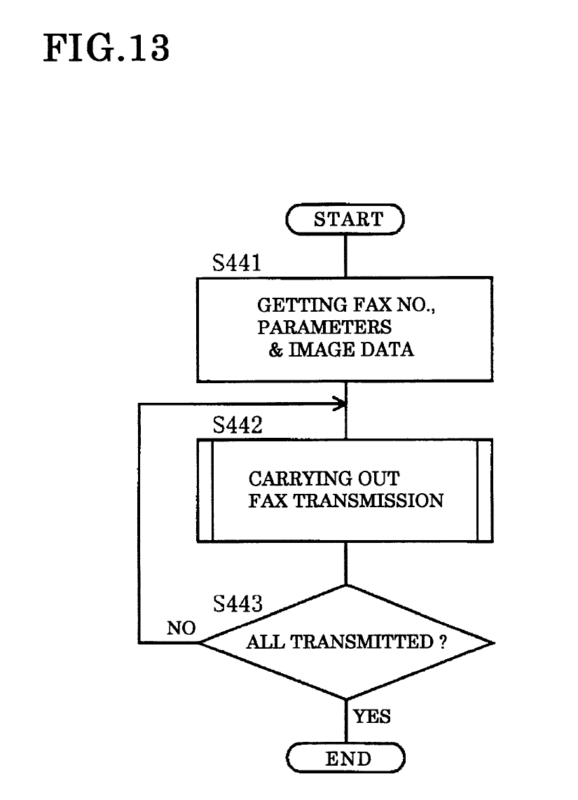

FIG. 13 is a flow chart of steps to be carried out by the facsimile controller 202A to store the designated time into the time indicator 401, in step S423.

An operator inputs a facsimile number of a facsimile receiver and various parameters necessary for data transmission, into the facsimile machine 201A, subsequently to pushing the first key. The facsimile controller 202A stores the thus input facsimile number and parameters, and further receives image data to be transmitted, from the scanner controller 214, in step S441. Herein, the parameters are the same as those having been explained in the first embodiment.

Then, the facsimile controller 202A transmits a command to the time indicator 401 to carry out facsimile data transmission at the designated time, in steps S442 and S443.

On receipt of the designated time, the time indicator 401 temporarily stores the designated time into an internal memory (not illustrated), or transmits a command to the protocol controller 212 to start facsimile data transmission at the designated time.

The facsimile controller 202A is necessary to know a current time for carrying out step S442. Hence, when an operator inputs the designated time, the facsimile controller 202A receives standard time data from the clock generator 206, transmits the received standard time data to the daylight saving time detector 207, and waits for receipt of time data from the daylight saving time detector 207.

On receipt of the standard time data from the time indicator 401, the daylight saving time detector 207 carries out the same steps as those steps illustrated in FIG. 8.

If the daylight saving time detector 207 judges that it is in the daylight saving time (YES in step S302), the daylight saving time detector 207 transmits the judgment result to the time controller 205, in step S303, in which case, the time controller 205 adjusts a standard time in accordance with the daylight saving time.

If the daylight saving time mode is not activated (NO in step S301), or if it is not in the daylight saving time (NO in step S302), the daylight saving time detector 207 transmits the judgment result to the time controller 205, in step S304, in which case, the time controller 205 does not adjust a standard time in accordance with the daylight saving time.

As having been explained with reference to FIG. 6, the facsimile controller 202A calculates a current time, in steps S274 and S276, based on the judgment result of the daylight saving time detector 207, and transmits the thus calculated current time to the time indicator 401.

On receipt of the adjusted current time, the time indicator 401 compares the received current time to the designated time stored in an internal memory, at which facsimile transmission is to start, and when the designated time has come, the time indicator 401 dials a receiver, and transmits the image data which the time indicator 401 received in step S441, through facsimile transmission, in step S424.

In the second embodiment, the facsimile machine 201A is designed to additionally include the time indicator 401 in comparison with the facsimile machine 201. However, it should be noted that the facsimile controller 202A might be designed to have the functions of the time indicator 401, in which case, the time indicator 401 may be omitted.

In the above-mentioned first and second embodiments, the time administrator in accordance with the present invention is applied to a facsimile machine. However, it should be noted that the time administrator in accordance with the present invention might be applied to any apparatuses, if they are necessary to administrate a time at which a certain action is to be carried out. For instance, the time administrator in accordance with the present invention may be applied to a video tape recorder or an electric cooking heater.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-385478 filed on Dec. 19, 2000 including specification, claims, drawings and summary is incorporated herein by reference in its entirety.

What is claimed is:

1. A time administrator comprising:
(a) a first unit which acts as a clock and transmits a first signal indicative of a standard time;
(b) a second unit which makes access to said first unit and receives said first signal;
(c) a third unit which judges whether a system for adjusting a current time is adapted and further whether said system is to be applied to said standard time; and
(d) a fourth unit which, when said third unit judges that said system is to be applied to said standard time, carries out a specific operation to said standard time, and transmits a second signal indicative of the result of said operation as a current time, and which, when said third unit judges that said system is not to be applied to said standard time, transmits a third signal without carrying out said operation which third signal is indicative of said standard time as a current time.

2. The time administrator as set forth in claim 1, wherein said system for adjusting a current time is a daylight saving time.

3. A time administrator comprising:
(a) a first unit which acts as a clock and transmits a first signal indicative of a standard time;
(b) a second unit which makes access to said first unit and receives said first signal;
(c) a third unit which judges whether a system for adjusting a current time is adapted and further whether said system is to be applied to said standard time;
(d) a fourth unit which, when said third unit judges that said system is to be applied to said standard time, carries out a specific operation to said standard time, and transmits a second signal indicative of the result of said operation as a current time, and which, when said third unit judges that said system is not to be applied to said standard time, transmits a third signal without carrying out said operation which third signal is indicative of said standard time as a current time, and
(e) a fifth unit which visually displays said current time indicated by said third signal.

4. The time administrator as set forth in claim 3, wherein said system for adjusting a current time is a daylight saving time.

5. The time administrator as set forth in claim 3, wherein said second unit makes access to said first unit when communication results are stored in a memory in a facsimile machine.

6. A time administrator comprising:
(a) a first unit which acts as a clock and transmits a first signal indicative of a standard time;
(b) a second unit which makes access to said first unit and receives said first signal;
(c) a third unit which judges whether a system for adjusting a current time is adapted and further whether said system is to be applied to said standard time; and
(d) a fourth unit which, when said third unit judges that said system is to be applied to said standard time, carries out a specific operation to said standard time, and transmits a second signal indicative of the result of said operation as a current time,
which, when said third unit judges that said system is not to be applied to said standard time, transmits a third signal without carrying out said operation which third signal is indicative of said standard time as a current time,
which compares said current time to a specific time at which a specific action has to start, and
which starts said specific action, if said current time is identical with said specific time.

7. The time administrator as set forth in claim 6, wherein said system for adjusting a current time is a daylight saving time.

8. The time administrator as set forth in claim 6, wherein said second unit makes access to said first unit when reservation for transmitting data through a facsimile machine is made.

9. A method of adjusting a time, comprising the steps of:
(a) judging whether a system for adjusting a current time is adapted and further whether said system is to be applied to a standard time; and
(b) carrying out a specific operation to said standard time, when said system is judged to be applied to said standard time, or transmitting a signal without carrying out said operation which signal is indicative of said standard time as a current time, when said system is judged not to be applied to said standard time.

10. The method as set forth in claim 9, wherein said system for adjusting a current time is a daylight saving time.

11. The method as set forth in claim 9, further comprising the step of visually displaying said current time indicated by said signal.

12. The method as set forth in claim 9, further comprising the steps of:
(c) comparing said current time to a specific time at which a specific action has to start; and
(d) starting said specific action, if said current time is identical with said specific time.

13. A facsimile machine comprising:
(a) a clock which transmits a first signal indicative of a standard time;
(b) a time controller which makes access to said clock and receives said first signal;
(c) a judging unit which judges whether a system for adjusting a current time is adapted and further whether said system is to be applied to said standard time;
(d) a facsimile controller which, when said judging unit judges that said system is to be applied to said standard time, carries out a specific operation to said standard time, and transmits a second signal indicative of the result of said operation as a current time, and which, when said judging unit judges that said system is not to be applied to said standard time, transmits a third signal without carrying out said operation which third signal is indicative of said standard time as a current time;
(e) a protocol controller connected to a communication line and controlling communication in said facsimile machine;
(f) a printer controller which controls an operation of a printer; and
(g) a scanner which reads data.

14. The facsimile machine as set forth in claim 13, wherein said system for adjusting a current time is a daylight saving time.

15. The facsimile machine as set forth in claim 13, further comprising a display unit which visually displays said current time indicated by said third signal.

16. The facsimile machine as set forth in claim 15, further comprising a memory, and wherein said time controller makes access to said first unit when communication results are stored in said memory.

17. The facsimile machine as set forth in claim 13, wherein said facsimile controller compares said current time to a specific time at which a specific action has to start, and starts said specific action, if said current time is identical with said specific time.

18. The facsimile machine as set forth in claim 16, wherein said time controller makes access to said clock when reservation for transmitting data through said facsimile machine is made.
